(19) United States
(12) Patent Application Publication
(10) Pub. No.: US 2010/0236695 A1
(43) Pub. Date: Sep. 23, 2010

(54) TIRE TREAD BLOCK COMPOSITION

(75) Inventors: MARK ALLAN LAMONTIA, LANDENBERG, PA (US); CONSTANTINE WILLIAM TSIMPRIS, MIDLOTHIAN, VA (US); GEON-SEOK KIM, WILMINGTON, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/728,456

(22) Filed: Mar. 22, 2010

Related U.S. Application Data
(60) Provisional application No. 61/161,873, filed on Mar. 20, 2009.

(51) Int. Cl. B29D 30/08; B60C 11/03

(52) U.S. Cl. 156/123; 152/209.1; 156/110.1

(57) ABSTRACT

The invention concerns tires having a composite tread block which comprises a cured elastomer and from 0.1 to 10 parts per hundred parts by weight of the elastomer of fibers characterized as having a tenacity of at least 6 grams per dtex and a modulus of at least 200 grams per dtex. A major portion of said fibers are oriented in a direction such that noise arising from tire tread contacting the road surface is reduced.

### BACKGROUND OF THE INVENTION

1. Field of the Invention

This invention is directed to tread block compositions that reduce tire noise.

2. Description of the Related Art

There is a continued need for improved performance of passenger car and truck tires. Key performance attributes include noise, handling, wear, rolling resistance, and ride comfort. Reduced tire noise is becoming an industry focus as tire companies strive to reduce noise radiated from automobile and truck tires. For example, the European Union is putting in place legislation to significantly reduce pass-by noise from tires.

Certain fibers have been utilized in the production of high performance tires. Published U.S. Patent Application No. 2002/0069948 teaches the use of short fibers at angles that are largely perpendicular to the tire surface. The purpose of these constructions is said to be improvement in handling and/or acceleration. Published U.S. Patent Application No. 2007/0221303 utilizes short fibers in a construction that enhances the tread directional stiffness. These fibers are said to be aligned somewhat perpendicular to the longitudinal, circumferential direction of the tread. U.S. Pat. No. 4,871,004 discloses aramid-reinforced elastomers where short, discontinuous, fibrillated aramid fibers are dispersed in rubber. The arrangements disclosed in this patent are said to maximize lateral (axial or circumferential) stiffness and modulus. These arrangements, however, are not taught to be beneficial for noise reduction.

### SUMMARY OF THE INVENTION

This invention is directed to a tire tread block having at least one layer comprising reinforcing fibers aligned substantially parallel to each other in a controlled angle of orientation within the tread block, wherein the orientation is selected such that it decreases noise generated from the action of the tire tread contacting the road surface. The invention is further directed to a method of decreasing noise generated by a tire tread by (a) identifying a mechanism or mechanisms of noise generation, (b) providing a tire tread compound, and (c) introducing into the tire tread compound reinforcing fibers with an orientation that is adapted to reducing tire tread noise based on the identified mechanism in step (a).

### BRIEF DESCRIPTION OF THE DRAWINGS

FIG. 1A is a representation of the tire tread block and coordinate system.

FIG. 1B is a representation of a different tread block embodiment

FIG. 2 is a cross section of one embodiment of tire tread for a tire.

FIG. 3 depicts orientation of planes in a common direction.

FIG. 4 depicts orientation of planes in two directions.

### DETAILED DESCRIPTION OF THE INVENTION

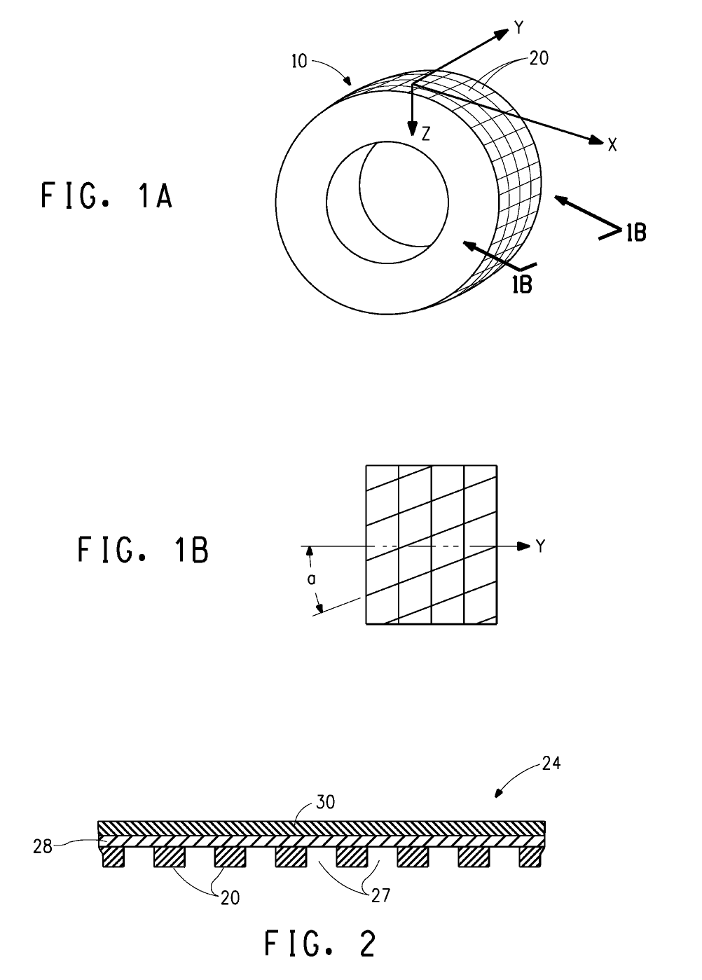

Vehicle tire noise arises from a number of sources. FIGS. 1A, 1B, and 2 will be helpful in describing how this noise arises. FIG. 1A shows generally at 10 a tire having tread blocks 20 and the principal coordinate axes pertaining to the tire. The tread blocks can be rectangular, as shown in FIG. 1A, or they can have angled shapes (as shown in FIG. 1B). The circumferential direction is in the direction of travel; X. The axial direction is shown as Y and the radial direction as Z. As a point of clarifying the spatial relationships, the road surface is in the XY plane. A tire also uses a component called a subtread 28 that provides support to the tread blocks 20 and is shown generally in FIG. 2. The subtread 28 is between the tread blocks and the first reinforced layer, which is either the overlay (cap ply), the belts, or the breakers 30. The tread blocks 20 and the subtread 28 form cavities 27.

One of the mechanisms of noise generation is called air pumping. Air pumping occurs when a tread block expands axially or circumferentially during contact with the road surface, moving the surrounding air. The major route is to pump out the air from the cavity volume formed between two neighboring tread blocks (side-by-side or fore and aft), the subtread at the roof of the cavity, and the road as the blocks and subtread expand upon contact with the road surface. A further route is simply the air being pumped by the lateral (axial or circumferential) motion of a single tread block. Air can be pumped out in either the circumferential or axial direction or an off axis direction when the block features an angular tread pattern as depicted in FIG. 1B. A second major noise source called Helmholtz resonance also occurs in the region of the tread block and road interface. Helmholtz resonance is generated by the increase then relief of pressure in the air cavity formed by neighboring (fore and aft) tread blocks. As the cavity reduces in volume just before its neighboring tread block reaches the tire contact patch, the pressure rises. Helmholtz noise is generated when this high pressure air is expelled through the small slit just before the tread block closes off the cavity. Helmholtz noise is generated in both the circumferential and axial directions. Thus, those two types of noise create four sources of noise during travel as follows:

1. Air pumping in the axial direction,
2. Air pumping in the circumferential direction.
3. Helmholtz noise in the axial direction,
4. Helmholtz noise in the circumferential direction,
Each noise source can be further exacerbated by a pipe resonance in the cavity and by the horn effect.

By judicious selection of fiber orientation and planar arrangement of layers in a tread block or a subtread, it is possible to customize tread block and subtread design to address specific noise reduction challenges. In some tire constructions, the fibers are substantially aligned axially within at least one of the tread block layers. In certain tires, in at least one of the tread block layers, fibers are substantially aligned with each other in a substantially circumferential direction. In certain tires, in at least one of the tread block layers, fibers are substantially aligned with each other in a substantially radial direction. By substantially we mean that over 50% of the short fibers within a layer are oriented in one direction. More preferably over 70% of the short fibers within a layer are oriented in one direction. Most preferably over 85% of the short fibers within a layer are oriented in one direction. By aligned or oriented is meant the fiber is arranged such that the long dimension of the fiber is oriented in the aligned direction. This fiber alignment gives anisotropic mechanical stiffness properties to the cured tread block. Also, the subtread can include fibers aligned in certain orientations to act in concert with the tread block to further minimize noise generation. This can be significant because in some cases, the subtread can have about one-third of the effect on noise reduction as does the tread block.

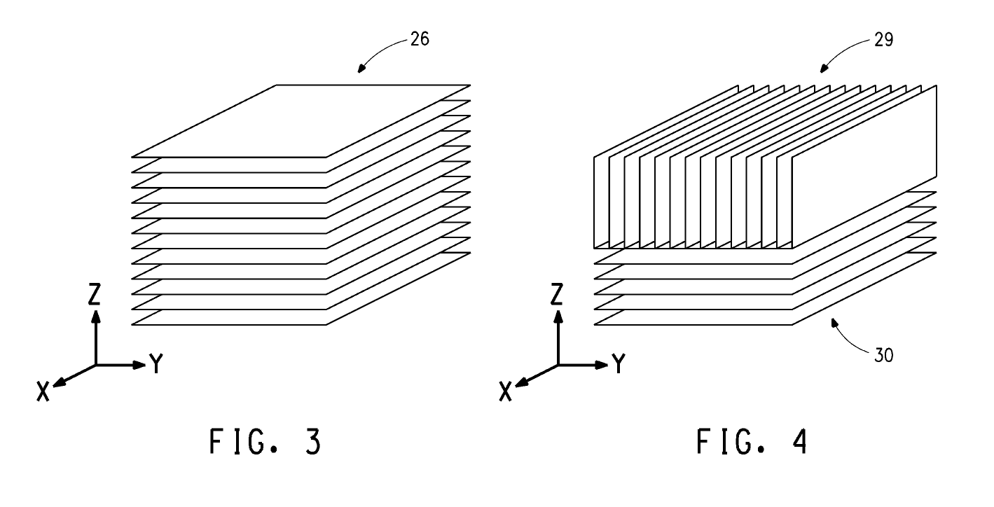

Further, a tread block or subtread may comprise a plurality of layers having different fiber orientation in adjacent layers. The layers containing the aligned fibers can also be oriented in different planar arrangements. For example, FIG. 3 depicts an XY planar orientation of layers. These layers could contain axially (Y) oriented fibers, circumferentially (X) oriented fibers, or fibers arranged to alternate between axial (Y) and circumferential (X) orientation. Fiber orientation could be likewise be different for the layers having different planar orientations as depicted in FIG. 4. For example, in the XZ planes, the fibers could be circumferential (X) or radial (Z), whereas in the XY planes, the fibers could be circumferential (X) or axial (Y). In the YZ plane, the fibers could be axial (Y) or radial (Z). It is recognized that noise generation from an actual tire used on a vehicle would have various configurations of tread blocks and grooves. However, the advantage of the invention can be described using a less complicated representation. There are many possible arrangements of fiber orientation when the tread blocks and subtread are viewed together as a noise—reduction structure. For example, it has been determined that fibers oriented axially and circumferentially in the tread blocks and fibers oriented radially in the sub-tread are very effective in reducing noise. On the other hand, orienting fibers circumferentially in both the subtread and the tread block may be the easiest to produce, but provide a smaller relative benefit in noise reduction. Between these two situations there is a plethora of possible fiber orientations in the subtread/tread block structure. For example, in further reference to FIG. 4, the fibers in an XZ plane of a subtread could be oriented at some angle between the circumferential (X) and radial (Z) directions. Likewise, the fibers in an XY plane of a subtread could be oriented at some angle between the circumferential (X) and axial (Y) directions. Appropriate choice of tooling and manufacturing systems including extrusion dies will result in the desired orientation of fiber in the extruded profile of each sub-tread.

When tread blocks are arranged in the tire at an offset angle as shown in FIG. 1B, the fiber alignment can remain in the original X, Y, and Z directions, or can be offset in the same orthogonal directions as the tread blocks. For example, if the tread blocks are offset at some angle ‘a’ with respect to the Y direction as can be seen from FIG. 1B, the reinforcement fibers can remain in the original X, Y, Z coordinate directions or may alternatively be similarly oriented at angle ‘a’ with respect to the Y direction. Orientation of the tread blocks with corresponding orientation of the fibers could likewise apply with respect to the X direction. Further, orientation of the tread blocks could likewise apply with respect to the Z direction as well, especially as the tread wraps around the crown/carcass interface on the side of the tire. In the general case, tread blocks are molded into a tire in the X, Y, and Z directions, and in many other angular orientations that change over the surface of the tire. Manufacturing considerations dictate that the rubber compound that is built into the tire have a uniform orientation independent of the tread block angular orientation. Thus, the reinforcements are designed to be effective whether they are aligned with the X, Y, and Z directions, or on an offset angle.

Although fiber orientation in layers in the XY, YZ, or XZ planes are preferred to be orthogonal, fibers may also be aligned non-orthogonally at an angle of between 5 to 85 degrees to either the circumferential, axial or radial directions. More preferably, the fibers are aligned at an angle between 15 and 70 degrees. Such bias angle orientation can be achieved by calendaring the elastomeric sheet in two directions.

Another aspect of the invention concerns processes for producing a composite tread block or subtread described herein, where the process comprises producing one or more layers by calendering or extruding a mixture of the elastomer and the reinforcing fiber. In some embodiments, the process additionally comprises consolidating a plurality of layers.

This invention in which there is controlled orientation of fibers in the elastomer thus differs from a carbon-black or other particulate reinforced rubber compound which manifests random or isotropic reinforcement, and which suffers from detrimental tread block hardening when the radial stiffness increases along with the lateral (axial and/or circumferential) stiffness. The axial reinforcement is added with short fibers, floc, or pulp. In some embodiments, the higher the short fiber or pulp modulus, the better is the obtained performance. Thus, high modulus fibers such as aramid fibers and pulp can advantageously placed in the plane of the tread block and subtread. It should be noted, however, that in addition to aramids, any short fibers or pulp that increase the axial tread block stiffness would work to some degree. Such fibers may be used directly during the compounding of the fiber or may be added as a premix or masterbatch in which the fiber is pre-blended into a concentrate with some of the elastomer.

The tread blocks or subtread of this invention comprise cured elastomer having from 0.1 to 10 parts per hundred parts by weight of the elastomer of short fibers, floc, or pulp. The fibers have a tenacity of at least 6 grams per dtex and a modulus of at least 200 grams per dtex. The short fibers may be produced from continuous fibers to form floc, pulp, and other chopped fiber forms and unless noted otherwise as discussed herein, any of these forms may be considered as fibers. Some fibers have a length to diameter ratio of 5 to 10,000, more preferably 10 to 5000. Short fibers having a diameter of less than 15 micrometers, as discussed herein relating to this invention, include pulp and fibers known as floc. Floc is made by cutting continuous fiber into short lengths from about 0.1 to 8 millimeters, more preferably from about 0.1 to 6 millimeters. Manufacture of such fibers is well known to those skilled in the art. Certain of these fibers, including those coated with an adhesion promoting agent, are available commercially.

Some fibers used in the present invention are in the form of pulp. Pulp comprises fibrillated fibers that in some cases are produced by chopping longer fibers. Aramid pulp, for example, can be made by refining aramid fibers and, in some embodiments, has a distribution of lengths up to about 8 millimeters with an average length of about 0.1 to 4 millimeters. Commercially available aramid pulps include Kevlar® pulp, from E.I. du Pont de Nemours and Company, Wilmington Del., (DuPont) and Teijin™ Twaron® pulp. Another form of pulp, known as micropulp, can be produced in accordance with US patent application number 2003/0114641. This pulp has a volume average length ranging from 0.01 micrometers to 100 micrometers and an average surface area ranging from 25 to 500 square meters per gram. As used herein, the volume average length means:

Σ(number of fibers of given length)×(length of each fiber)4/Σ(number of fibers of given length)×(length of each fiber)3

### Fiber Polymer

The fibers and pulp used herein can be made from any polymer that produces a high-strength fiber, including, for example, aromatic or aliphatic polyamides, aromatic or aliphatic polyesters, polyacrylonitrile, polyolefins, cellulose, polyazoles and mixtures of these.

When the polymer is polyamide, in some embodiments, aramid is preferred. The term “aramid” means a polyamide wherein at least 85% of the amide (—CONH—) linkages are attached directly to two aromatic rings. Suitable aramid fibers include Twaron®, Sulfron®, Technora® all available from Teijin Aramid, Heracon™ from Kolon Industries Inc. or Kevlar® available from Dupont. Aramid fibers are described in Man-Made Fibres—Science and Technology, Volume 2, Section titled Fibre-Forming Aromatic Polyamides, page 297, W. Black et al., Interscience Publishers, 1968. Aramid fibers and their production are, also, disclosed in U.S. Pat. Nos. 3,767,756; 4,172,938; 3,869,429; 3,869,430; 3,819,587; 3,673,143; 3,354,127; and 3,094,511.

In some embodiments, the preferred aramid is a para-aramid. One preferred para-aramid is poly (p-phenylene terephthalamide) which is called PPD-T. By PPD-T is meant the homopolymer resulting from mole-for-mole polymerization of p-phenylene diamine and terephthaloyl chloride and, also, copolymers resulting from incorporation of small amounts of other diamines with the p-phenylene diamine and of small amounts of other diacid chlorides with the terephthaloyl chloride. As a general rule, other diamines and other diacid chlorides can be used in amounts up to as much as about 10 mole percent of the p-phenylene diamine or the terephthaloyl chloride, or perhaps slightly higher, provided only that the other diamines and diacid chlorides have no reactive groups which interfere with the polymerization reaction. PPD-T, also, means copolymers resulting from incorporation of other aromatic diamines and other aromatic diacid chlorides such as, for example, 2,6-naphthaloyl chloride or chloro- or dichloroterephthaloyl chloride or 3,4′-diaminodiphenylether.

Additives can be used with the aramid and it has been found that up to as much as 10 percent or more, by weight, of other polymeric material can be blended with the aramid. Copolymers can be used having as much as 10 percent or more of other diamine substituted for the diamine of the aramid or as much as 10 percent or more of other diacid chloride substituted for the diacid chloride or the aramid.

When the polymer is polyolefin, in some embodiments, polyethylene or polypropylene is preferred. Polyolefin fibers can only be used when the processing temperatures required to compound the fiber and elastomer, to calender or extrude the compound or to cure the compound in the tire assembly is less than the melting point of the polyolefin. The term “polyethylene” means a predominantly linear polyethylene material of preferably more than one million molecular weight that may contain minor amounts of chain branching or comonomers not exceeding 5 modifying units per 100 main chain carbon atoms, and that may also contain admixed therewith not more than about 50 weight percent of one or more polymeric additives such as alkene-1-polymers, in particular low density polyethylene, propylene, and the like, or low molecular weight additives such as anti-oxidants, lubricants, ultra-violet screening agents, colorants and the like which are commonly incorporated. Such is commonly known as extended chain polyethylene (ECPE) or ultra high molecular weight polyethylene (UHMWPE). Preparation of polyethylene fibers is discussed in U.S. Pat. Nos. 4,478,083, 4,228,118, 4,276,348 and 4,344,908. High molecular weight linear polyolefin fibers are commercially available. Preparation of polyolefin fibers is discussed in U.S. Pat. No. 4,457,985.

In some preferred embodiments polyazoles are polyarenazoles such as polybenzazoles and polypyridazoles. Suitable polyazoles include homopolymers and, also, copolymers. Additives can be used with the polyazoles and up to as much as 10 percent, by weight, of other polymeric material can be blended with the polyazoles. Also copolymers can be used having as much as 10 percent or more of other monomer substituted for a monomer of the polyazoles. Suitable polyazole homopolymers and copolymers can be made by known procedures, such as those described in or derived from U.S. Pat. Nos. 4,533,693, 4,703,103, 5,089,591, 4,772,678, 4,847,350, and 5,276,128.

Preferred polybenzazoles include polybenzimidazoles, polybenzothiazoles, and polybenzoxazoles and more preferably such polymers that can form fibers having yarn tenacities of 30 grams per denier (gpd) or greater. In some embodiments, if the polybenzazole is a polybenzothioazole, preferably it is poly (p-phenylene benzobisthiazole). In some embodiments, if the polybenzazole is a polybenzoxazole, preferably it is poly (p-phenylene benzobisoxazole) and more preferably the poly (p-phenylene-2,6-benzobisoxazole) called PBO.

Preferred polypyridazoles include polypyridimidazoles, polypyridothiazoles, and polypyridoxazoles and more preferably such polymers that can form fibers having yarn tenacities of 30 gpd or greater. In some embodiments, the preferred polypyridazole is a polypyridobisazole. One preferred poly(pyridobisozazole) is poly(1,4-(2,5-dihydroxy)phenylene-2,6-pyrido[2,3-d:5,6-d′]bisimidazole which is called PIPD. Suitable polypyridazoles, including polypyridobisazoles, can be made by known procedures, such as those described in U.S. Pat. No. 5,674,969.

The term “polyester” as used herein is intended to embrace polymers wherein at least 85% of the recurring units are condensation products of dicarboxylic acids and dihydroxy alcohols with linkages created by formation of ester units. This includes aromatic, aliphatic, saturated, and unsaturated di-acids and di-alcohols. The term “polyester” as used herein also includes copolymers (such as block, graft, random and alternating copolymers), blends, and modifications thereof. In some embodiments, the preferred polyesters include poly (ethylene terephthalate), poly (ethylene naphthalate), and liquid crystalline polyesters. Poly (ethylene terephthalate) (PET) can include a variety of comonomers, including diethylene glycol, cyclohexanedimethanol, poly(ethyl ene glycol), glutaric acid, azelaic acid, sebacic acid, isophthalic acid, and the like. In addition to these comonomers, branching agents like trimesic acid, pyromellitic acid, trimethylolpropane and trimethyloloethane, and pentaerythritol may be used. The poly (ethylene terephthalate) can be obtained by known polymerization techniques from either terephthalic acid or its lower alkyl esters (e.g. dimethyl terephthalate) and ethylene glycol or blends or mixtures of these. Another potentially useful polyester is poly (ethylene napthalate) (PEN). PEN can be obtained by known polymerization techniques from 2, 6 napthalene dicarboxylic acid and ethylene glycol.

Liquid crystalline polyesters may also be used in the invention. By “liquid crystalline polyester” (LCP) herein is meant polyester that is anisotropic when tested using the TOT test or any reasonable variation thereof, as described in U.S. Pat. No. 4,118,372. One preferred form of liquid crystalline polyesters is “all aromatic”; that is, all of the groups in the polymer main chain are aromatic (except for the linking groups such as ester groups), but side groups which are not aromatic may be present.

E-Glass is a commercially available low alkali glass. One typical composition consists of 54 weight % SiO₂, 14 weight % Al₂O₃, 22 weight % CaO/MgO, 10 weight B₂O₃ and less then 2 weight % Na₂O/K₂O, Some other materials may also be present at impurity levels.

S-Glass is a commercially available magnesia-alumina-silicate glass. This composition is stiffer, stronger, more expensive than E-glass and is commonly used in polymer matrix composites.

Carbon fibers are commercially available and well known to those skilled in the art. In some embodiments, these fibers are about 0.005 to 0.010 mm in diameter and composed mainly of carbon atoms.

Cellulosic fibers can be made by spinning liquid crystalline solutions of cellulose esters (formate and acetate) with subsequent saponification to yield regenerated cellulosic fibers.

### Elastomer

As used herein, the terms “rubber” and “elastomer” may be used interchangeably, unless otherwise provided. The terms “rubber composition”, “compounded rubber” and “rubber compound” may be used interchangeably to refer to “rubber which has been blended or mixed with various ingredients and materials” and such terms are well known to those having skill in the rubber mixing or rubber compounding art. The terms “cure” and “vulcanize” may be used interchangeably unless otherwise provided: In the description of this invention, the term “phr” refers to parts of a respective material per 100 parts by weight of rubber, or elastomer.

The elastomers of the present invention include both natural rubber, synthetic natural rubber and synthetic rubber. Synthetic rubbers compounds can be any which are dissolved by common organic solvents and can include, among many others, polychloroprene and sulfur-modified chloroprene, hydrocarbon rubbers, butadiene-acrylonitrile copolymers, styrene butadiene rubbers, chlorosulfonated polyethylene, fluoroelastomers, polybutadiene rubbers, polyisoprene rubbers, butyl and halobutyl rubbers and the like. Natural rubber, styrene butadiene rubber, polyisoprene rubber and polybutadiene rubber are preferred. Mixtures of rubbers may also be utilized.

### Production of Tire Block Layers & Tires

In some aspects, the invention concerns processes for producing a composite tread block and/or subtread described herein, where the process comprises producing one or more layers by calendering or extruding a mixture of the elastomer and the reinforcing fiber. The process can additionally comprise consolidating a plurality of the layers. Different layers may or may not have the same fiber orientation. Methods of calendering, extruding and consolidating layers are well known to those skilled in the art and are described below. The subtread can be formed by means well known to those skilled in the art. Tread can be formed in the tread block by means well known to those skilled in the art. Various grooves and designs are used in the trade to improve road grip, especially on wet, snow-covered, or ice-covered surfaces. Attachment of the tread block to the tire can also be performed by methods well known to those skilled in the art.

Fiber alignment may be achieved by several well known methods. One process involves high shear mixing of raw materials (polymer, fiber, and other additives) to compound the elastomer followed by roll milling and/or calendering. The high shear mixing ensures that the fiber and other additives are uniformly dispersed in the elastomer. At this stage, the fibers within the elastomer are randomly oriented. The first phase of the compounding process involves mastication or breaking down of the polymer. Natural rubber may be broken down on open roll mills but it is more common practice to use a high shear mixer having counter rotating blades such as a Banbury or Shaw mixer. Sometimes a separate premastication step may be used. For synthetic rubbers, premastication is only necessary when the compound contains a blend of polymers. This is followed by masterbatching when most of the ingredients are incorporated into the rubber. This ensures a thorough and uniform dispersion of ingredients in the rubber. During the mixing process it is important to keep the temperature as low as possible. Ingredients not included in this step are those constituting the curing system. These are normally added in the last step, usually at a lower temperature.

An example of a typical mixing process is as follows. This is for a two stage mixing of Kevlar® pulp dispersed in an elastomer (Kevlar® engineered elastomer (Kevlar® EE)) into a neoprene type rubber.

First stage
Add successively, while mixing, half the Neoprene, then the Kevlar® EE and finally the remaining Neoprene and magnesium oxide
Mix effectively for 1-1.5 minutes
Add loose fibers (if any)
Mix at least 30 seconds
Add fillers, plasticizers, antioxidant and other additives
Raise mixer speed as needed to achieve the desired temperature and continue mixing until good dispersion of the fiber has been obtained,
Sheet off the first stage compound at a dumping temperature not exceeding 105-110° C. and allow to cool.
Second stage
Add successively half the cooled first stage, followed by zinc oxide, curatives and the remainder of the first pass mix.
Dump at 100-105° C. into a sheeting mill.

Further information on elastomer compounding is contained in pages 496 to 507 of The Vanderbilt Rubber Handbook, Thirteenth Edition, published by R. T. Vanderbilt Company Inc., Norwalk, Conn., and in U.S. Pat. Nos. 5,331,053; 5,391,623; 5,480,941 and 5,830,395.

In some circumstances, mixing of ingredients can also be achieved by roll milling. Fiber alignment is achieved during the calendering and/or milling process which is carried out under heat and pressure. A calendar is a set of multiple large diameter rolls that squeeze rubber compound into a thin sheet.

Another approach is to use an extrusion process in which the raw materials are mixed and extruded into a sheet in a single process. The extruder consists of a screw and barrel, screw drive, heaters and a die. The extruder applies heat and pressure to the compound. By appropriate selection of the extrusion die channel design and geometry, the fibers may be aligned in the X, Y, or Z directions within the extrudate corresponding to the circumferential, axial and radial directions in the tread. In a converging die, the channel thickness decreases towards the die exit resulting in fibers being aligned in the machine direction (circumferential direction within the plane of the extruded sheet). Insertion of a baffle plate in a die assembly will result in the fibers aligning in the cross-machine direction within the plane of the extruded sheet. A die design in which the thickness of the channel opening increases towards exit face of the die will give a fiber orientation perpendicular to the plane of the extruded sheet. For tire treads, the die cross sectional profile is adapted to the desired tread design and the tread can be extruded in one piece. In such a tread, all the fibers are aligned in the direction governed by the chosen die. Should different fiber orientations be desired in different sections or zones across the tread, then multiple die heads are required with each die being selected to give the desired fiber orientation appropriate for that zone.

There are three main stages in the production of a tire, namely component assembly, pressing, and curing. In component assembly, a drum or cylinder is used as a tool onto which the various components are laid. During assembly the various components are either spliced or bonded with adhesive. A typical sequence for layup of tire components is to first position a rubber sheet inner liner. Such a liner is compounded with additives that result in low air permeability. This makes it possible to seal air in the tire. The second component is a layer of calendered body ply fabric or cord coated with rubber and an adhesion promoter. The body ply or plies is turned down at the edges of the drum. Steel beads are applied and the liner ply is turned up. Beads are bands of high tensile strength steel wire encased in a rubber compound and provide the strength to mechanically fit the tire to the wheel. Bead rubber includes additives to maximize strength and toughness. Next the apex is positioned. The apex is a triangular extruded profile that mates against the bead and provides a cushion between the rigid bead and the flexible inner liner and body ply assembly. This is followed by a pair of chafer strips and the sidewalls. These resist chafing from the wheel rim when mounted on a vehicle. The drum is then collapsed and the first stage assembly is ready for the second component assembly stage.

Second stage assembly is done on an inflatable bladder mounted on steel rings. The green first stage assembly is fitted over the rings and the bladder inflates it up to a belt guide assembly. Steel belts to provide puncture resistance are then placed in position. The belts are calendered sheets consisting of a layer of rubber, a layer of closely spaced steel cords, and a second layer of rubber. The steel cords are oriented radially in a radial tire construction and at opposing angles in a bias tire construction. Passenger vehicle tires are usually made with two or three belts. The final component, the tread rubber profile of subtread and tread block layers is then applied. These profile strips contain the oriented fiber of this invention. The tread assembly is rolled to consolidate it to the belts and the finished assembly (green cover) is then detached from the machine. Many higher-performance tires include an optional extruded cushion component between the belt package and the tread to isolate the tread from mechanical wear from the steel belts. If desired the tire building process can be automated with each component applied separately along a number of assembly points.

Following layup, the assembly is pressed to consolidate all the components into a form very close to the final dimension of the tire.

Curing or vulcanizing of the elastomer into the final tire shape takes place in a hot mold. The mold is engraved with the tire tread pattern. The green tire assembly is placed onto the lower mold bead seat, a rubber bladder is inserted into the green tire and the mold closed while the bladder inflates to a pressure of about 25 kgf/cm². This causes the green tire to flow into the mold taking on the tread pattern. The bladder is filled with a recirculating heat transfer medium such as steam, hot water or inert gas. Cure temperature and curing time will vary for different tire types and elastomer formulations but typical values are a cure temperature of about 150 to 180 degrees centigrade with a curing time from about 12 to 25 minutes. For large tires, the cure time can be much longer. At the end of the cure, the pressure is bled down, the mold opened and the tire stripped out of the mold. The tire may be placed on a post-cure inflator that will hold the tire fully inflated while it cools.

Representative Advantages of Alignment of the Fibers with the Tire

Another aspect of the invention concerns processes for producing a composite tread block or subtread described herein, where the process comprises producing one or more layers by calendaring a mixture of the elastomer and the reinforcing fiber. In some embodiments, the process additionally comprises consolidating a plurality of the layers. Techniques for aligning the fibers in the elastomer are processes that develop shear conditions during the mixing/compounding step. Such methods include milling, calendering, injection molding and extrusion. Examples of these techniques can be found in U.S. Pat. Nos. 6,106,752 (injection molding); 6,899,782 (extrusion) and 7,005,022 (extrusion and needling).

### Examples

The invention is illustrated by the following examples that are designed to be illustrative but not limiting in nature, wherein all parts, proportions, and percentages are by weight unless otherwise indicated.

The experimental process comprised formulating rubber compounds, forming slabs of rubber, cutting test coupons representing either tread blocks or subtreads, subjecting the coupons to deformation tests, measuring the deformations, inputting the measured deformations into a finite element analysis to deduce the actual mechanical moduli and Poisson's ratio properties from the measured data, further using those properties to model the tire, tread block, and subtread deformations so as to predict the tread block and subtread deformations, and finally to predict the noise reduction attributable to the tread block or subtread design.

For the purpose of predicting noise reduction in the following examples, identical test specimens, both in composition and dimensions, were used to represent the tread block and the subtread. In the construction of a conventional tire different compositions may be used for the subtread and tread blocks.

### Test Methods

Fiber tenacity was determined in accordance with ASTM D 7269 and is the maximum or breaking stress of a fiber as expressed as force per unit cross-sectional area. The tenacity was measured on an Instron Model 1130 available from Instron Engineering Corp. of Canton, Mass. and is reported as grams per denier (grams per dtex).

Fiber modulus was determined in accordance with ASTM D 7269 and is the slope of the tangent line to the initial straight line portion of the stress strain curve, multiplied by 100 and divided by the adhesive-free denier. The modulus is generally recorded at less than 2% strain. The modulus is calculated from the stress strain curve measured on an Instron Model 1130 available from Instron Engineering Corp. of Canton, Mass. and is reported as grams per denier (grams per dtex).

Rubber block deformation was tested in accordance with ASTM 575-91.

In the following examples, the amount of fiber was present at either zero parts, 2 parts or 6 parts per hundred parts of rubber (phr) in the compounded rubber. The fiber was added as a premix of 23% aramid fiber in 77% of TSR20 natural rubber. The premix was identified as merge 1F722, which may be hereafter referred to as Kevlar®EE.

The compounded rubber was prepared using the following materials:

Styrene butadiene rubber type 1502 from ISP Elastomers LP, Port Nechas, Tex.
Natural rubber type SMR CV (60) from Akrochem Corporation, Akron, Ohio.
Aramid fiber elastomeric dispersion merge 1F722 available from DuPont.
Carbon black type N-299 from Columbian Chemicals Co. Marietta, Ga.
Aromatic oil Sundex oil grade 790 from Sunoco, Philadelphia, Pa.
Zinc oxide from Zinc Corp. of America, Monica, Pa.
Stearic acid from Crompton Corp, Greenwich, Conn.
Light stabilizer Vanwax H Special from R.T. Vanderbilt, Norwalk, Conn.
Antioxidant, Antozite 67P, from R.T. Vanderbilt, Norwalk, Conn.
Vanox O₂ antioxidant (Agerite resin D) from R.T. Vanderbilt, Norwalk, Conn.
Cure accelerator, Amax, from R.T. Vanderbilt, Norwalk, Conn.
Secondary accelerator, Vanax DPG, from R.T. Vanderbilt, Norwalk, Conn.
Sulfur from S.F. Sulfur Corp., Valdosta, Ga.
Compounded rubber samples were prepared according to the formulations as per Table 1.

TABLE 1

| | | Compound 1 | Compound 2 |
|---|---|---|---|
| | Compound A | (6 phr of | (2 phr of |
| Ingredient | No fiber | fiber) | fiber) |
| SBR 1502 | 50 | 50 | 50 |
| SMR CV(60) | 50 | 29.9* | 43.3 |
| 1F722 | 0 | 26.1* | 8.7 |
| Carbon Black | 45 | 45 | 45 |
| Sundex Oil | 9 | 9 | 9 |
| Vanwax H | 1 | 1 | 1 |
| Antozite 67P | 2 | 2 | 2 |
| Vanox 2 Resin | 1 | 1 | 1 |
| Stearic Acid | 3 | 3 | 3 |
| Zinc Oxide | 3 | 3 | 3 |
| Sulfur | 1.6 | 1.6 | 1.6 |
| Amax | 0.8 | 0.8 | 0.8 |
| Vanax DPG | 0.4 | 0.4 | 0.4 |

*The 26.1 phr 1F722 contains 6 phr aramid in 20.1 phr of SMR CV (60) rubber which when added to the 29.9 phr of SMR CV (60) rubber already in the compound yields 50 phr total of SMR CV (60) rubber.

The rubber was compounded in a Banbury mixer. A pre-mix was prepared by adding the aramid dispersion to half the quantity of rubber polymers and mixing for 40 seconds. The second half of the rubber polymers was then added, the mixer closed and mixing continued for one minute. All dry ingredients were added in the sequence of carbon black, Sundex 790, Vanwax H, Antozite 67P, Agerite resin and stearic acid. The mixer was closed and mixing continued until a temperature of 74° C. was reached. The ram and throat parts of the mixer were then swept clean and the pre-mix removed from the mixer.

The final mix was prepared by adding half the quantity of pre-mix followed by the curative ingredients Amax, Vanax DPG, sulfur and zinc oxide. Finally the other half pre-mix was added, the ram and throat swept clean and mixing continued for 40 seconds maintaining the temperature below 99° C. The finished compounded rubber was then removed from the mixer.
The compounded rubber was then calendered to a thickness of 3.5 mm. The fiber orientation takes place during this calendering process.

Tread blocks were prepared from the compounded calendered sheets prepared above by cutting the sheets into pieces having nominal dimensions of 152 mm×90 mm×25 mm thick and stacking eight layers of sheets in a press mold. The mold was then placed in a press and the samples cured at 160° C. for 60 minutes. Example Cl was made from compound A and is the control. Examples 3, 5, 7, 8-10, 11-14, and 18-26 were made entirely of compound 1. Examples 2, 4, 6, were made from compound 2. Examples 15-17 featured treadblocks made from compound 2 and subtread made from compound 1.

The cured slabs of elastomer were then cut by water jet in to nominal 25.4 mm cubes. These cubes are representative of the subtread and tread blocks. The XY, XZ and YZ faces of the cubes were tested in compression according to ASTM 575-91. Prior to testing, the cubes were preconditioned by compressing each face of the cube 7.62 mm twenty times. The preconditioned blocks were then compressed from 25 mm to a thickness of 17.38 mm in an Instron universal test machine at a rate of 2.54 mm/min. Prior to each test, the dimensions of the specimen block were measured using a Mitutoyo indicator mounted to a gauge stand. Measurements were taken at each of the four corners and the center of each face. The average of the measurements was considered to be the dimension of the specimen. Before placing the block in the test rig, the surfaces of the block that would contact the compression fixture plates were lightly smeared with vacuum grade grease. Deflection of the block faces under the compressive load was measured using an Aramis Model 3D Deformation Noncontact Dual Image Correlation Analyzer available from GOM Optical Measuring Techniques, Braunschweig, Germany. By compressing the various faces of the block the influence of fiber orientation within the block can be observed.

Measured deformation data was input into a finite element analysis model based on ABAQUS release 6.91 software to predict the actual mechanical properties of the tread block and subtread material. Then, the finite element analysis was used to simulate deformations of the actual tire, tread block and subtread upon contact with the roadway. Tread block and subtread deformation predictions were, in turn, input into acoustic computer program, Virtual. Lab Rev. 8A-SL1, to predict the resulting noise.

The results shown in Tables 2 through 6 demonstrate that orientation of fiber in certain directions gives reduced deflection of the tread block and/or subtread that in turn corresponds to less noise generated from a tire. This allows the tailoring of fiber orientation, in particular tire tread and/or subtread designs, to address specific noise issues. Table 2 further summarizes the findings.

TABLE 2
Deflections from Fiber Reinforced Tread Blocks

| Reinforcement | Noise Reduction & Block Face Deflection | |
|---|---|---|
| Orientation | | Helmholtz in |
| in Block (Plane | Helmholtz in axial direction | circumferential direction |
| & Preferred | and air pumping in axial | and air pumping in |
| Orientation) | direction | circumferential direction |
| XY plane, | Some Improvement | Significant |
| predominantly | (15% less deflection) | Improvement |
| circumferential | | (49% less deflection) |
| XY plane, | Significant Improvement | Some Improvement |
| predominantly | (49% less deflection) | (15% less deflection) |
| axial | | |
| XZ plane, | No Improvement | Significant |
| predominantly | (13% worse deflection) | Improvement |
| circumferential | | (52% less deflection) |
| XZ plane, | Significant Improvement | Significant |
| predominantly | (45% less deflection) | Improvement |
| radial | | (38% less deflection) |
| YZ plane, | Significant Improvement | No Improvement |
| predominantly | (52% less deflection) | (13% worse deflection) |
| axial | | |
| YZ plane, | Significant Improvement | Significant |
| predominantly | (38% less deflection) | Improvement |
| radial | | (45% less deflection) |

In this table by “significant improvement” we mean that the tread block lateral (circumferential or axial) deflection under load is reduced by at least 35% compared to a block without fibrous reinforcement. By “some improvement” we mean that the tread block lateral deflection under load is reduced by between 1% to 35% compared to a block without fibrous reinforcement. This provides a reduction in the noise generated by the tread/road interface. Thus, there is reduced interior noise heard by either the driver or passenger of a moving vehicle such as an automobile or a truck. There is also a reduction in the pass-by noise heard by someone outside of the vehicle.

From Table 2, advantageous effects of the invention can be demonstrated by the judicious selection of various fiber orientations. For example, we see that if the aramid fiber is introduced in the XY plane with the primary reinforcement in the Y (axial) direction, there would be multiple benefits. The Helmholtz and air pumping noise caused by circumferential deflection would reduce by 15% to 85% of the original value when using unreinforced tread blocks because the deflection would reduce by that amount. More impressively, the air pumping and Helmholtz noise caused by axial deflection would reduce by 49% to only 51% of the original value when using the unreinforced tread blocks because the deflection would reduce by that amount. Again, from the table, we see that if aramid fiber is introduced in the XY plane, with the primary reinforcement in the X (circumferential) direction, there would be multiple benefits. The Helmholtz and air pumping noise caused by axial deflection would reduce to 85% of the original value when using unreinforced tread blocks because the deflection would reduce by that amount. More impressively, the Helmholtz and air pumping noise caused by circumferential deflection would reduce to only 51% of the original value with the unreinforced tread blocks because the deflection would reduce by that amount. Again, from the table, we see that if aramid fiber is introduced in the XZ plane, with the primary reinforcement in the X (circumferential) direction, there would be a primary benefit only in the circumferential direction, although it would be large. That is, the Helmholtz and air pumping noise caused by circumferential deflection would reduce to 48% of the original value with the unreinforced tread blocks because the deflection would reduce by that amount.

Tables 3, 4, 5, and 6 show the actual acoustic predictions for the tires. Table 3 shows monolithic Kevlar® EE tread blocks with non-reinforced rubber compound in the subtread. The term “monolithic” as used here means that the portion of tread block material closer to the road surface is the same as the portion of tread block material closer to the subtread whereas non-monolithic means that the portions are different orientations. Table 4 shows non-reinforced monolithic isotropic rubber tread blocks and Kevlar® EE reinforced subtread. Table 5 shows non-monolithic Kevlar® EE reinforced rubber tread blocks and isotropic non-reinforced subtread. Table 6 shows monolithic Kevlar® EE reinforced rubber tread blocks and Kevlar® EE reinforced subtread.

TABLE 3

| | | | | | Sound |
|---|---|---|---|---|---|
| | | | | Volume | Pressure |
| | Tread Block | Reinforcement | | Change | Level |
| Ex | Material | Orientation | | Ratio | Reduction |
| C1 | Isotropic Rubber | N/A | | 1.00 | — |
| 2 | 2 phr | Y | Axial | 1.20 | 1.40 |
| 3 | 6 phr | Y | Axial | 1.76 | 4.10 |
| 4 | 2 phr | Z | Radial | 1.47 | 2.90 |
| 5 | 6 phr | Z | Radial | 2.42 | 7.10 |
| 6 | 2 phr | X | Circumferential | 1.10 | 1.00 |
| 7 | 6 phr | X | Circumferential | 1.34 | 2.90 |

In Table 3, the acoustic benefit of using Kevlar® EE as a tread block material is shown when tread blocks are reinforced but the subtread is made from unreinforced rubber compound. In particular, the acoustic benefit of using 2 phr Kevlar® EE and 6 phr® Kevlar® EE is presented along with the performance of a real tire with unreinforced tread block compound. All models are for noise in front of the tire. In Example 2, if 2 phr Kevlar® EE tread blocks are used with the orientation in the Y or axial direction, the acoustic benefit is a lowering of noise level by 1.4 dB. If reinforced in the X or circumferential direction, the acoustic benefit is to lower the noise level by 1.0 dB. If reinforced in the Z or radial direction, the acoustic benefit is to lower the noise level by 2.9 dB. When using 6 phr Kevlar® EE in the Y, Z, or X directions, the acoustic benefit improves, and the noise level falls by 4.1 dB, 7.1 dB, and 2.9 dB, respectively.

TABLE 4

| | | | | | Sound |
|---|---|---|---|---|---|
| | | | | Volume | Pressure |
| | Subtread | Reinforcement | | Change | Level |
| Ex | Material | Orientation | | Ratio | Reduction |
| C1 | Isotropic Rubber | N/A | | 1.00 | — |
| 8 | 6 phr | Y | Axial | 1.12 | 0.80 |
| 9 | 6 phr | Z | Radial | 1.17 | 1.40 |
| 10 | 6 phr | X | Circumferential | 1.06 | 0.60 |

In Table 4, the benefit of using Kevlar® EE in the subtread is shown when in each example, the tread blocks are made from unreinforced rubber compound. In each example in Table 4, the subtread is reinforced with 6 phr Kevlar® EE. For reinforcement in the Y-axial, Z-radial, or X-circumferential, the acoustic benefit is a reduction of noise by 0.8 dB, 1.4 dB, and 0.6 dB, respectively.

TABLE 5

| | Upper | Upper Tread block | | Lower | Lower Tread block | | Volume | |
|---|---|---|---|---|---|---|---|---|
| | Tread block | Reinforcement | | Treablock | Reinforcement | | Change | SPL |
| Ex | Material | Orientation | | Material | Orientation | | Ratio | reduction |
| C1 | Isotropic | N/A | | Isotropic | N/A | | 1.00 | — |
| | Rubber | | | Rubber | | | | |
| 11 | 6 phr | Y | Axial | 6 phr | X | Circumferential | 1.58 | 3.70 |
| 12 | 6 phr | Y | Axial | 6 phr | Z | Radial | 2.02 | 5.40 |
| 13 | 6 phr | X | Circumferential | 6 phr | Y | Axial | 1.51 | 3.60 |
| 14 | 6 phr | X | Circumferential | 6 phr | Z | Radial | 1.69 | 4.60 |

In Table 5, the benefits of complex tread blocks are shown when the subtread is made from unreinforced rubber. For the table, the tread blocks are called complex as they have reinforcement in one direction near the road, but in another direction near the subtread. In Example 11, the upper (near the subtread) tread block reinforcement is Y-axial and the lower (near the road) tread block reinforcement is X-circumferential. In that example, the acoustic benefit is 3.7 dB. In Example 12, the upper (near the subtread) tread block reinforcement is Y-axial but the lower (near the road) tread block reinforcement is Z-radial. In that example, the acoustic benefit is 5.4 dB. In Example 13, the upper (near the subtread) tread block reinforcement is X-circumferential and the lower (near the road) tread block reinforcement is Y-axial. In that example, the acoustic benefit is 3.6 dB. In Example 14, the upper (near the subtread) tread block reinforcement is X-circumferential and the lower (near the road) tread block reinforcement is Z-radial. In that case, the acoustic benefit is 4.6 dB.

TABLE 6

| | | | | | | | | Sound |
|---|---|---|---|---|---|---|---|---|
| | | Tread block | | | Subtread | | Volume | Pressure |
| | Tread block | Reinforcement | | Subtread | Reinforcement | | Change | Level |
| Ex | Material | Orientation | | Material | Orientation | | Ratio | Reduction |
| C1 | Isotropic | N/A | | Isotropic | N/A | | 1 | — |
| | Rubber | | | Rubber | | | | |
| 15 | 2 phr | Y | Axial | 6 phr | Y | Axial | 1.35 | 2.3 |
| 16 | 2 phr | X | Circumferential | 6 phr | Y | Axial | 1.24 | 1.8 |
| 17 | 2 phr | Z | Radial | 6 phr | Y | Axial | 1.66 | 3.9 |
| 18 | 6 phr | Y | Axial | 6 phr | Y | Axial | 2 | 5.3 |
| 19 | 6 phr | X | Circumferential | 6 phr | Y | Axial | 1.52 | 4.0 |
| 20 | 6 phr | Z | Radial | 6 phr | Y | Axial | 2.83 | 8.3 |
| 21 | 6 phr | Y | Axial | 6 phr | X | Circumferential | 1.89 | 5.3 |
| 22 | 6 phr | X | Circumferential | 6 phr | X | Circumferential | 1.43 | 3.6 |
| 23 | 6 phr | Z | Radial | 6 phr | X | Circumferential | 2.57 | 7.8 |
| 24 | 6 phr | Y | Axial | 6 phr | Z | Radial | 2.11 | 5.8 |
| 25 | 6 phr | X | Circumferential | 6 phr | Z | Radial | 1.6 | 4.4 |
| 26 | 6 phr | Z | Radial | 6 phr | Z | Radial | 2.98 | 8.6 |

Table 6 shows the acoustic benefit of more complex reinforcement motifs. In particular, these are the most general cases of reinforcement as both the tread block and the subtread are reinforced; they can have the same or different reinforcement. Example 15 shows the acoustic benefit when the tread blocks are reinforced with 2 phr Kevlar® EE in the Y-axial direction and the subtread is reinforced with 6phr Kevlar® EE in the axial direction, the sound reduction is 2.3 dB. Example 16 shows the acoustic benefit when the tread blocks are reinforced with 2 phr Kevlar® EE in the X-circumferential direction and the subtread is reinforced with 6phr Kevlar® EE in the Y-axial direction, the sound reduction is 1.8 dB. Example 17 shows the acoustic benefit when the tread blocks are reinforced with 2 phr Kevlar® EE in the Z-radial direction and the subtread is reinforced with 6 phr Kevlar® EE in the axial direction, the sound reduction is 3.9 dB. A number of other examples are shown. The column titled “subtread reinforcement orientation” shows that all directions for subtread reinforcement have been considered, including the Y-axial, the X-circumferential, and the Z-radial. For subtread 6 phr Y-axial reinforcement, Examples 18, 19, and 20, the tread block is oriented in the Y-axial, X-circumferential, and Z-radial directions. The acoustic benefit is 5.3 dB, 4.0 dB, and 8.3 dB, respectively. For subtread 6 phr X-circumferential reinforcement, Examples 21, 22, and 23, the tread block is oriented in the Y-axial, X-circumferential, and Z-radial directions, and the acoustic benefit is 5.3 dB, 3.6 dB, and 7.8 dB, respectively. For subtread 6 phr Z-radial reinforcement, Examples 24, 25, and 26, the tread block is oriented in the Y-axial, X-circumferential, and Z-radial directions, and the acoustic benefit is 5.8 dB, 4.4 dB, and 8.6 dB, respectively.

What is claimed:

1. A tire tread block having at least one layer comprising reinforcing fibers aligned substantially parallel to each other in a controlled angle of orientation within the tread block wherein the orientation is selected such that it decreases tire tread noise.

2. The tire tread block of claim 1, wherein the reinforcing fibers are in an orientation selected from the group consisting of circumferential, axial, radial, and combinations thereof.

3. The tire tread block of claim 1 comprising a cured elastomer and from 0.25 to 6 parts per hundred parts of elastomer of the reinforcing fiber having a tenacity of at least 6.3 grams per dtex and a modulus of at least 200 grams per dtex.

4. The tire tread block of claim 1, wherein the fibers are made from a polymer selected from the group consisting of aromatic polyamides, aliphatic polyamides, polyesters, polyolefins, polyazoles, and mixtures thereof.

5. The tire tread block of claim 4, wherein aromatic polyamide is p-aramid.

6. The tire tread block of claim 1, wherein said cured elastomer is selected from the group consisting of natural rubber, styrene butadiene rubber, butadiene rubber and mixtures thereof.

7. The tire tread block of claim 1, wherein the reinforcing fibers in at least one XY or XZ layer are in a circumferential orientation.

8. The tire tread block of claim 1, wherein the reinforcing fibers in at least one XY or YZ layer are in an axial orientation.

9. The tire tread block of claim 1, wherein the reinforcing fibers in at least one XZ or YZ layer are in a radial orientation.

10. The tire tread block of claim 1 comprising a plurality of layers, wherein the fibers in adjacent layers are in an orientation substantially perpendicular to each other.

11. The tire tread block of claim 1, wherein the reinforcing fibers are aligned in at least one XY, XZ or YZ layer such that the fibers are not aligned orthogonally within the layer.

12. The tire tread block of claim 1, having a subtread attached thereto, wherein the subtread comprises reinforcing fibers aligned substantially parallel to each other in a controlled angle of orientation within the subtread wherein the orientation is selected such that it decreases tire noise.

13. The tire tread block of claim 12, wherein the subtread comprises reinforcing fibers in a circumferential orientation in at least one XY or XZ layer.

14. The tire tread block of claim 12, wherein the subtread comprises reinforcing fibers in an axial orientation in at least one XY or YZ layer.

15. The tire tread block of claim 12, wherein the subtread comprises reinforcing fibers in a radial orientation in at least one XZ or YZ layer.

16. The tire tread block of claim 12, wherein the subtread comprises reinforcing fibers that are aligned in at least one XY, XZ, or YZ layer such that the fibers are not aligned orthogonally within the layer.

17. A method of decreasing noise generated by a tire tread block or subtread, comprising the steps of.
(a) identifying a mechanism generating the noise
(b) providing a tire tread block or subtread compound,
(c) introducing into the tire tread block or subtread compound reinforcing fibers with an orientation that is adapted to reducing tire tread block or subtread noise based on the identified mechanism in step (a).

18. A process for producing a tire comprising a composite tire tread block or subtread, the composite further comprising:
a cured elastomer; and
from 0.1 to 10 parts per hundred parts by weight of said elastomer of fibers; said fibers being characterized as having a tenacity of at least 6 grams per dtex and a modulus of at least 200 grams per dtex,
wherein a major portion of said fibers are substantially oriented in a plane substantially parallel to or orthogonal to said road contact surface in one or more layers;
said process comprising the steps of
(a) compounding in a high shear mixer, roll mill or extruder an uncured elastomer comprising short fiber, elastomer and other additives,
(b) calendering or extruding said uncured elastomer into one or more layers or sheets having a tire tread block subtread profile in which the fibers are aligned in the desired direction,
(c) assembling the first stage components of a tire assembly in sequence on a drum,
(d) assembling the second stage components of a tire assembly, including the subtreads and tread block profiles, in sequence on a bladder press tool, and
(e) placing the tire assembly in a mold and curing the elastomeric compounds by heat and pressure.

19. The process of claim 18, comprising consolidating a plurality of said layers.
